(19) United States
(12) Patent Application Publication
(10) Pub. No.: US 2012/0078846 A1
(43) Pub. Date: Mar. 29, 2012

(54) SYSTEMS AND METHODS OF MANAGING VIRTUAL STORAGE RESOURCES

(76) Inventors: Stephen Gold, Fort Collins, CO (US); Jeffrey S. Tiffan, Greeley, CO (US); Sri Harshan Kapanipathi, Bangalore (IN)

(21) Appl. No.: 12/889,824

(22) Filed: Sep. 24, 2010

(51) Int. Cl. G06F 17/30

(52) U.S. Cl. 707/644; 707/E17.007

(57) ABSTRACT

Systems and methods of managing virtual storage resources are disclosed. An exemplary method includes analyzing parameters of a plurality of backup jobs over time to model backup lifecycle. The method also includes estimating size of available storage capacity over time based on the modeled backup lifecycle. The method also includes identifying storage options using the available storage capacity on an ongoing basis for future backup jobs.

### BACKGROUND

Storage devices commonly implement data backup operations (e.g., backup, deduplication) using local and/or remote virtual library storage (VLS) for data recovery. Adding backup jobs places additional demand on the VLS product, and can unacceptably degrade performance and/or exceed device hardware limits. Factors that may impact performance include the additional storage capacity that will be needed for the backup job (including retained versions and working space), and available storage capacity during peak usage.

However, determining the amount of available storage capacity is complicated for a number of reasons. For example, so-called “straight-line” regression analysis often cannot be used because not all backup jobs are full-length backup jobs. Some backup jobs are full-length, while other backup jobs are incremental. In addition, when using a deduplication-enabled VLS product with post processing, the deduplication process may use additional storage capacity for the post-processing, and also compress data at various times. Accordingly, the available storage capacity is variable over time. These and other factors make it difficult for a user to determine whether a backup job can be added to the VLS product without exceeding device hardware limits and/or unacceptably degrading performance.

### BRIEF DESCRIPTION OF THE DRAWINGS

FIG. 1 is a high-level diagram showing an exemplary storage system including both local and remote storage.

FIG. 2 shows exemplary software architecture which may be implemented in the storage system for managing virtual storage resources.

FIG. 3 is a flow diagram illustrating exemplary operations which may be implemented for managing virtual storage resources.

### DETAILED DESCRIPTION

Systems and methods are disclosed for managing virtual storage resources, e.g., for backup. It is noted that the term “backup” is used herein to refer to backup operations including echo-copy and other proprietary and non-proprietary data operations now known or later developed. Briefly, a storage system is disclosed including a local storage device and a remote storage device. Data (e.g., backup data for an enterprise) may be backed-up to a virtual storage library at the local storage device. The data may also be replicated by the local storage device onto another virtual storage library at the remote storage device.

Briefly, the lifecycle (or retention period) of a first backup cannot be used to accurately predict storage requirements over time because new backups are written to new tapes, subsequent backups may be incremental, old data may be overwritten, deduplication may add or remove data, and so forth. Therefore, the systems and methods described herein model lifecycle(s) of backups and apply trend analysis to the modeled lifecycle(s) in order to better manage virtual storage resources.

Before continuing, it is noted that any of a wide variety of storage products may also benefit from the teachings described herein, e.g., files sharing in network-attached storage (NAS) or other backup devices. In addition, the remote virtual library (or more generally, “target”) may be physically remote (e.g., in another room, another building, offsite, etc.) or simply “remote” relative to the local virtual library. It is also noted that exemplary operations described herein may be embodied as logic instructions on one or more computer-readable medium. When executed by one or more processor, the logic instructions cause a general purpose computing device to be programmed as a special-purpose machine that implements the described operations.

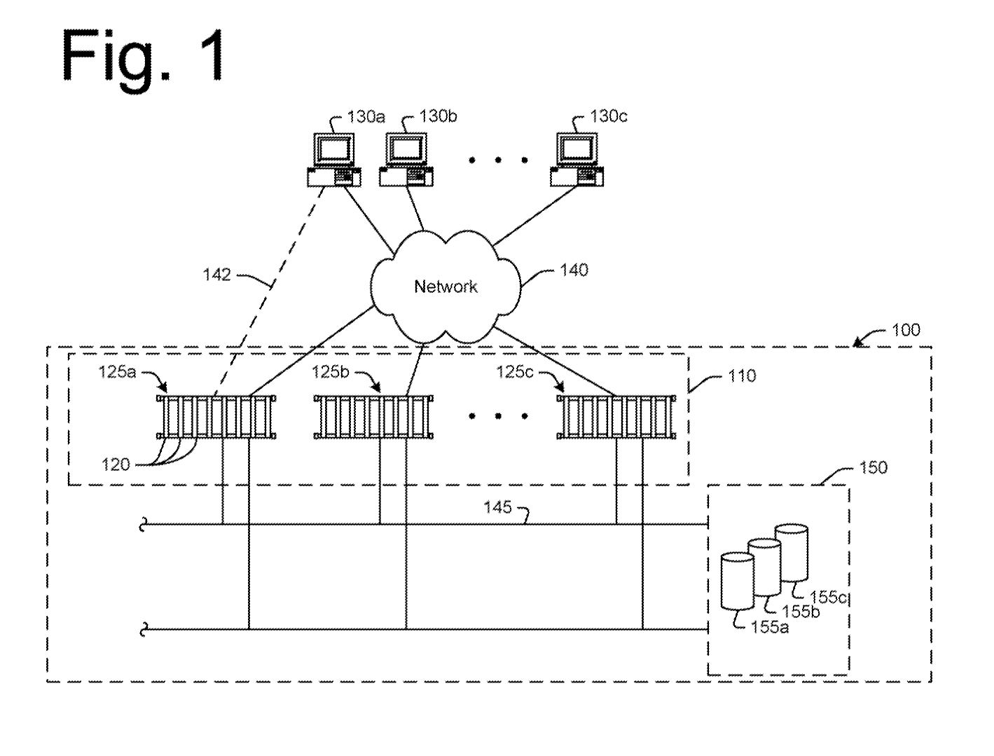

FIG. 1 is a high-level diagram showing an exemplary storage system 100. Exemplary storage system may include local storage device 110 and may include one or more storage cells 120. The storage cells 120 may be logically grouped into one or more virtual library storage (VLS) 125a-c (also referred to generally as local VLS 125) which may be accessed by one or more client computing device 130a-c (also referred to as “clients”), e.g., in an enterprise. In an exemplary embodiment, the clients 130a-c may be connected to storage system 100 via a communications network 140 and/or direct connection (illustrated by dashed line 142). The communications network 140 may include one or more local area network (LAN) and/or wide area network (WAN). The storage system 100 may present virtual libraries to clients via a unified management interface (e.g., in a “backup” application).

It is also noted that the terms “client computing device” and “client” as used herein refer to a computing device through which one or more users may access the storage system 100. The computing devices may include any of a wide variety of computing systems, such as stand-alone personal desktop or laptop computers (PC), workstations, personal digital assistants (PDAs), server computers, or appliances, to name only a few examples. Each of the computing devices may include memory, storage, and a degree of data processing capability at least sufficient to manage a connection to the storage system 100 via network 140 and/or direct connection 142.

In exemplary embodiments, the data is stored on one or more local VLS 125. Each local VLS 125 may include a logical grouping of storage cells. Although the storage cells 120 may reside at different locations within the storage system 100 (e.g., on one or more appliance), each local VLS 125 appears to the client(s) 130a-c as an individual storage device. When a client 130a-c accesses the local VLS 125 (e.g., for a read/write operation), a coordinator coordinates transactions between the client 130a-c and data handlers for the virtual library.

Redundancy and recovery schemes may be utilized to safeguard against the failure of any cell(s) 120 in the storage system. In this regard, storage system 100 may communicatively couple the local storage device 110 to the remote storage device 150 (e.g., via a back-end network 145 or direct connection). As noted above, remote storage device 150 may be physically located in close proximity to the local storage device 110. Alternatively, at least a portion of the remote storage device 150 may be “off-site” or physically remote from the local storage device 110, e.g., to provide a further degree of data protection.

Remote storage device 150 may include one or more remote virtual library storage (VLS) 155a-c (also referred to generally as remote VLS 155) for replicating data stored on one or more of the storage cells 120 in the local VLS 125. Although not required, in an exemplary embodiment, deduplication may be implemented for replication.

Deduplication has become popular because as data growth soars, the cost of storing data also increases, especially backup data on disk. Deduplication reduces the cost of storing multiple backups on disk. Because virtual tape libraries are disk-based backup devices with a virtual file system and the backup process itself tends to have a great deal of repetitive data, virtual tape libraries lend themselves particularly well to data deduplication. In storage technology, deduplication generally refers to the reduction of redundant data. In the deduplication process, duplicate data is deleted, leaving only one copy of the data to be stored. Accordingly, deduplication may be used to reduce the required storage capacity because only unique data is stored. That is, where a data file is conventionally backed up X number of times, X instances of the data file are saved, multiplying the total storage space required by X times. In deduplication, however, the data file is only stored once, and each subsequent time the data file is simply referenced back to the originally saved copy.

With a virtual tape library that has deduplication, the net effect is that, over time, a given amount of disk storage capacity can hold more data than is actually sent to it. For purposes of example, a system containing 1 TB of backup data which equates to 500 GB of storage with 2:1 data compression for the first normal full backup.

If 10% of the files change between backups, then a normal incremental backup would send about 10% of the size of the full backup or about 100 GB to the backup device. However, only 10% of the data actually changed in those files which equates to a 1% change in the data at a block or byte level. This means only 10 GB of block level changes or 5 GB of data stored with deduplication and 2:1 compression. Over time, the effect multiplies. When the next full backup is stored, it will not be 500 GB, the deduplicated equivalent is only 25 GB because the only block-level data changes over the week have been five times 5 GB incremental backups. A deduplication-enabled backup system provides the ability to restore from further back in time without having to go to physical tape for the data.

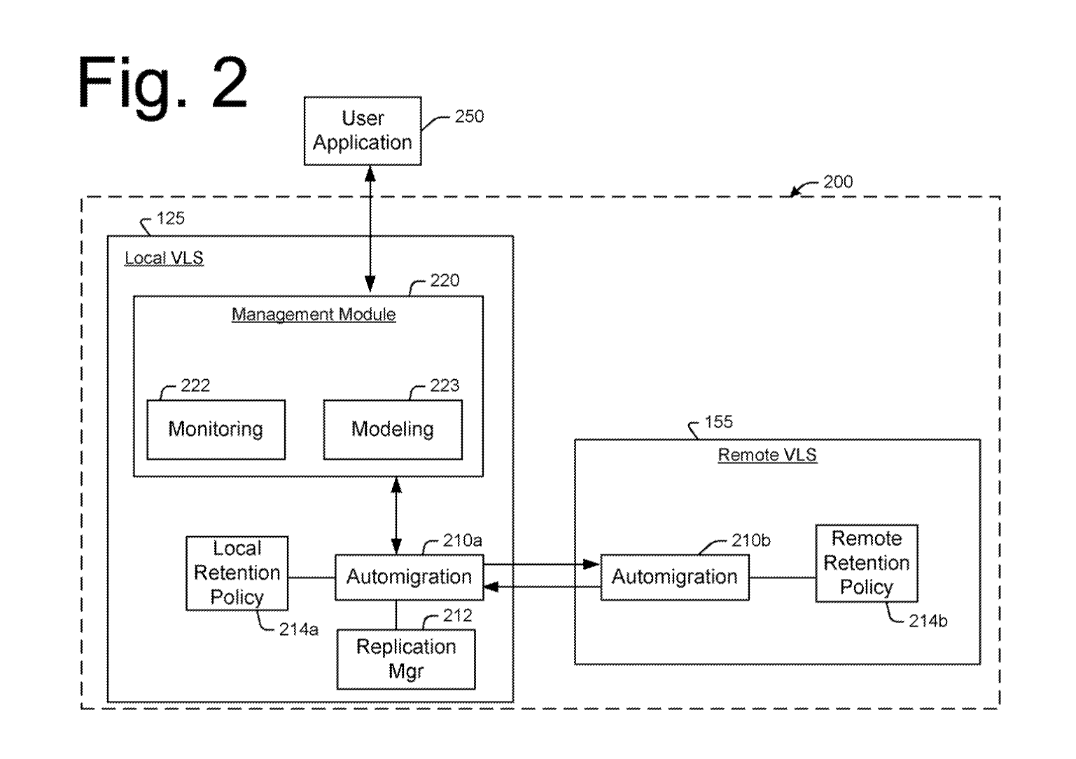

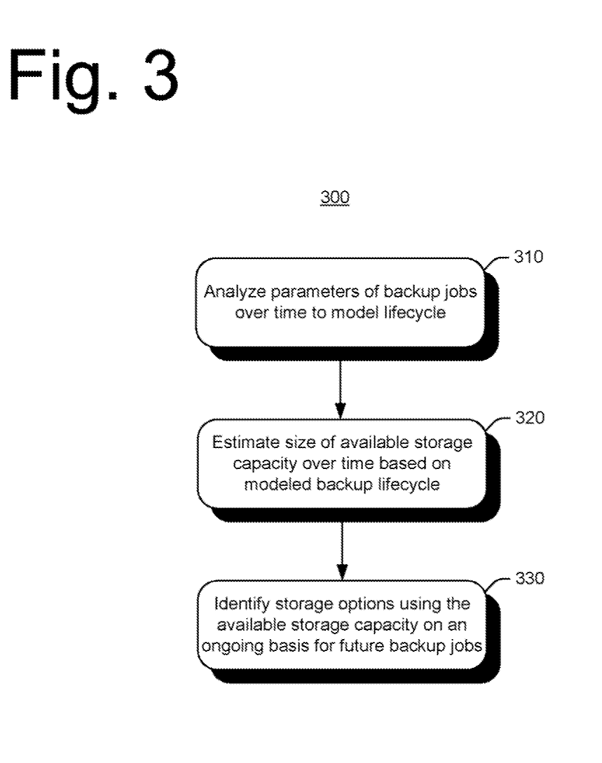

Regardless of whether deduplication is used, device management and data handling may be enhanced by managing the virtual storage resources. Systems and methods for managing virtual storage resources, such as a VLS product, may be better understood by the following discussion and with reference to FIGS. 2 and 3.

FIG. 2 shows exemplary software architecture 200 which may be implemented in the storage system 100 for managing virtual storage resources. For purposes of illustration, the virtual storage resources may be implemented in a VLS product, although the disclosure is not limited to use with a VLS product. The components shown in FIG. 2 may be implemented in program code (e.g., firmware and/or software and/or other logic instructions) stored on one or more computer readable medium and executable by a processor in the VLS product to perform the operations described below. It is noted that these components are provided for purposes of illustration and are not intended to be limiting.

In an embodiment, automigration components 210a, 210b may be provided at each of the local VLS 125 and remote VLS 155. The automigration component 210a at the local VLS 125 may be communicatively coupled to the automigration component 210b at the remote VLS 155 to handle replication between the local VLS 125 and remote VLS 155.

At the local VLS 125, automigration component 210a may also include a replication manager 212. Replication manager 212 may cooperate with the automigration component 210b at the remote VLS 155 to move at least one virtual tape from the local VLS 125 to the remote VLS 155. Replication manager 212 may also be implemented as program code, and is enabled for managing replication of data between the local VLS 125 and remote VLS 155. It is noted that in other embodiments, backup application-controlled replication may be utilized. In such embodiments, the policy engine that determines when a virtual tape is ready to be replicated and a prioritization and job scheduling scheme is included in the product as described here, or as part of an application residing on one or more client systems.

In order to replicate data from the local VLS 125 to the remote VLS 155, the replication manager 212 provides a software link between the local VLS 125 and the remote VLS 155. The software link enables data (e.g., copy/move jobs, setup actions, etc.) to be automatically transferred from the local VLS 125 to the remote VLS 155. In addition, the configuration, state, etc. of the remote VLS 155 may also be communicated between the automigration components 210a, 210b.

It is noted that although implemented as program code, the automigration components 210a, 210b may be operatively associated with various hardware components for establishing and maintaining a communications link between the local VLS 125 and remote VLS 155, and for communicating the data between the local VLS 125 and remote VLS 155 for replication.

It is also noted that the software link between automigration components 210a, 210b may also be integrated with deduplication technologies. In use, the user can set up replication at the local VLS 125 via the replication manager 212, and run replication jobs in a user application 250 (e.g., the “backup manager”) to replicate data from the local VLS 125. While the term “backup manager” is used herein, any application that supports replication operations may be implemented.

The automigration component 210a at the local VLS 125 may be operatively associated with a storage management module 220. Storage management module 220 may also be operatively associated with the user application 250 for managing virtual storage resources.

In an exemplary embodiment, the user may input parameters to the user application 250 (and/or the user application 250 may define these) for use by the storage management module 220. The parameters define one or more characteristics for a backup job. These characteristics may include the job type (e.g., full or incremental, or deduplication), job size, job retention policy (e.g., which replications are retained and for how long), job frequency, and compression factor (e.g., the compression ratio and the daily change rate at the block level).

These parameters are then analyzed by the storage management module 220 to model one or more backup lifecycle for existing and planned backup jobs. Modeling the backup lifecycle also includes consideration of the current device characteristics and usage, and how the storage capacity is changing over time (the change rate of data).

Storage capacity may vary over time (e.g., from day to day during the week) because the size of data being backed up varies each time a backup job is run (e.g., full versus incremental, or standard backup versus deduplication). For purposes of illustration, the user may set a retention or lifecycle policy 214a, 214b which runs a weekly 100 GB full backup and daily incremental backups at 10% of the full backup (e.g., 10 GB each). But the lifecycle of a first backup cannot be used to accurately predict storage requirements over time because new backups are written to new tapes, subsequent backups may be incremental, old data may be overwritten, deduplication may add or remove data, and so forth.

Therefore, the storage management module 220 may model lifecycle(s) of backups and apply trend analysis to the modeled lifecycle(s) in order to better manage the virtual storage resources. The analysis may also take into consideration how much storage space is returned to the available storage pool and when. For example, storage space is not immediately reclaimed (e.g., returned to the available storage pool) because doing so requires processing power and therefore may only be scheduled at predetermined times. In addition, not all storage space is returned to the available storage pool (e.g., some pointers, etc. are not erased).

In an embodiment, a monitor component 222 “looks back” over an actual usage time (e.g., the previous 7 days) to determine the storage capacity utilization. The monitor component 222 may be implemented to monitor (e.g., measure and record during operation or at some predetermined timing) one or both of logical capacity and physical capacity. In an exemplary embodiment, the monitor component 222 may record at desired intervals (e.g., regularly such as hourly) the logical and/or physical capacity for a particular VTL or VTLs (e.g., when multiple VTLs are configured on the same physical VLS and each VTL may have different characteristics). It is also possible to measure the logical and physical capacity of each virtual cartridge in a VTL. Because it can be determined which virtual cartridges are currently loaded into a particular VTL, the total logical and physical capacity can be determined for each VTL.

A modeling component 223 may utilize the parameters from the user application and the storage capacity determined by the monitoring component 222 to generate a modeled lifecycle.

It is noted that the storage capacity used in the model lifecycle may include both logical capacity and physical capacity. Logical capacity is the total amount of backup data that will be written to the device during one retention cycle. For example, if the lifecycle policy is to retain twenty full backup jobs on the device, and the full backup size is 10 GB then the estimator component 211 determines that the logical capacity is 20×10=200 GB.

Physical capacity depends at least in part whether deduplication is enabled or disabled. When deduplication is not enabled, physical capacity is the logical backup capacity divided by the average compression ratio (e.g., standard compression). However, when deduplication is enabled, then the physical capacity is based on how much the logical data is reduced by deduplication and the removing of duplicate data across multiple versions of the replication. Because deduplication may be different for incremental and full backups, the physical capacity is based on retention rate (e.g., how many copies of incremental and full backups), number of full backups (e.g., per month), and the daily percentage change. Post-processing working space for the deduplication processes also impacts physical capacity.

The management module 220 may use the generated lifecycle information to manage the virtual storage resources. In an embodiment, the management module 220 may manage the virtual storage resources by determining the maximum storage capacity available on each VTL based on the current backups. For purposes of illustration, each virtual cartridge may be held in a “storage pool,” where the storage pool may be a collection of disk array LUNs. There can be one or multiple storage pools in a single VLS product, and the virtual cartridges in those storage pools can be loaded into any VTL. In addition, the virtual cartridge capacity can be set (e.g., by the user) to be more or less than the actual storage capacity (e.g., that of the physical disk)—referred to as the “allocated” capacity.

The management module 220 may determine an “allocated” capacity for a VTL as follows. If all of the virtual cartridges in the VTL are held in one or more storage pool dedicated to that particular VTL, then the storage pool capacity is the total usable disk size of the storage pool(s). But a storage pool may also be shared across multiple VTLs, in which case the capacity is divided across the number of VTLs based on virtual cartridge allocation.

If the allocated cartridge capacity is larger than the storage pool capacity then the maximum capacity of the VTL is the storage pool capacity. But if the allocated capacity is smaller than the storage pool capacity then the maximum capacity of the VTL is the allocated cartridge capacity.

The management module 220 may also determine the maximum theoretical logical size of backups based on the current VTL information. This determination may be based on the current free disk space available (e.g., the maximum disk capacity for a VTL minus the used disk capacity for that VTL), multiplied by the current average overall “system ratio” (e.g., the current logical capacity for a VTL divided by used disk capacity for that VTL). The maximum theoretical logical backup size is an estimate of how many more logical backups can be stored in the VTL.

Accordingly, storage requirements for the VLS product can be more accurately managed to avoid exceeding performance metrics (e.g., actual hardware limits and/or preferred use). Although not limited to any particular usage environment, the ability to better schedule and manage virtual storage resources for backup jobs is particularly desirable in a service environment where a single VLS product may be shared by multiple users (e.g., different business entities), and each user can determine whether to add a backup job to the user's own virtual tape library within the VLS product.

Before continuing, it is noted that backup policies, such as described herein, may be based on any of a variety of different factors, such as, but not limited to, storage limitations, corporate policies, or as otherwise determined by the user or recommended by a manufacturer or service provider.

FIG. 3 is a flow diagram 300 illustrating exemplary operations which may be implemented for managing virtual storage resources. In operation 310, parameters of a plurality of backup jobs over time are analyzed to model backup lifecycle. The parameters may include at least size, number, and frequency of the plurality of backup jobs. The parameters also include at least type of replication. Type of replication may include at least full backups, incremental backups, and deduplications.

In operation 320, the size of available storage capacity over time is estimated based on actual use based on the modeled backup lifecycle. The capacity may be logical and/or physical capacity. In operation 330, storage options are identified using the available storage capacity on an ongoing basis for future backup jobs. Storage options may include, but are not limited to, scheduling backup jobs, number and type of replication, and location of replications.

Other operations (not shown in FIG. 3) may also be implemented in other embodiments. For example, other operations may include determining a rate of change of available storage capacity. The rate of change of available storage capacity may include at least how much data changes over time and how frequently data changes over time. The rate of change of available storage capacity may also include at least frequency and amount of storage space reclaimed as the available storage capacity.

Further operations may include, for example, trend analysis on the current capacity/performance data. In another example, replication between VLS products may also be analyzed. Existing measurements on replication (e.g., throughput for a replication link, throttling, blackout windows, etc.) may be used to determine the current link usage. The user may define the maximum bandwidth and service level (e.g., how long before a backup job is safely replicated).

It is noted that the exemplary embodiments shown and described are provided for purposes of illustration and are not intended to be limiting. Still other embodiments are also contemplated for determining impact on virtual storage resources.

1. A method of managing virtual storage resources, comprising:
analyzing parameters of a plurality of backup jobs over time to model backup lifecycle;
estimating size of available storage capacity over time based on the modeled backup lifecycle; and
identifying storage options using the available storage capacity on an ongoing basis for future backup jobs.

2. The method of claim 1, wherein the capacity is logical and/or physical capacity.

3. The method of claim 1, wherein the parameters of the plurality of backup jobs include at least size, number, and frequency.

4. The method of claim 1, wherein the parameters of the plurality of backup jobs include at least type of replication.

5. The method of claim 4, wherein type of replication includes at least full backups, incremental backups, and deduplications.

6. The method of claim 1, further comprising determining a rate of change of available storage capacity.

7. The method of claim 6, wherein rate of change of available storage capacity includes at least how much data changes over time and how frequently data changes over time.

8. The method of claim 6, wherein rate of change of available storage capacity includes at least frequency and amount of storage space reclaimed as the available storage capacity.

9. A storage system comprising logic stored on a computer-readable medium, the logic executable by a processor to:
analyze a plurality of backup jobs to model backup lifecycle; and
identify storage options for at least one of the backup jobs by estimating available storage capacity using the modeled backup lifecycle.

10. The storage system of claim 9, wherein capacity is physical capacity based on a number of dedicated virtual cartridges versus shared virtual cartridges.

11. The storage system of claim 9, wherein information on the plurality of backup jobs is provided by a backup manager.

12. The storage system of claim 11, wherein the information provided by the backup manager includes at least change rate of data.

13. The storage system of claim 11, wherein the information provided by the backup manager includes at least type of replication.

14. The storage system of claim 11, wherein the information provided by the backup manager includes at least frequency of replication.

15. The storage system of claim 11, wherein the information provided by the backup manager includes at least number of replication.
